(19) United States
(12) Patent Application Publication
(10) Pub. No.: US 2008/0000376 A1
(43) Pub. Date: Jan. 3, 2008

(54) Method for Controlling a Machine for Processing Sheet Material

(75) Inventors: Holger Wiese, Obertshausen (DE); Bernd Lindner, Heusenstamm (DE); Helmut Schild, Steinbach/Ts (DE); Lothar Kuhlmeyer, Darmstadt (DE); Bernd Marneth, Gross-Zimmern (DE); Joachim Blumor, Hainburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: MAN Roland Druckmaschinen AG, Offenbach (DE)

(21) Appl. No.: 11/659,997

(22) PCT Filed: Jul. 28, 2005
(86) PCT No.: PCT/EP05/08160

§ 371 Date: Mar. 28, 2007

(30) Foreign Application Priority Data
Aug. 13, 2004 (DE) 10 2004 039 536.5

(51) Int. Cl. B41D 7/00

(52) U.S. Cl. 101/493

(57) ABSTRACT

The invention concerns a method for controlling a machine for processing sheet material that has at least one individually driven cylinder. The method involves interrupting a pressure contact in a contact zone between a plate cylinder 10 as a directly driven cylinder and a neighboring rubber blanket cylinder 8. The plate cylinder 10 is then turned by the direct drive from its particular angular position into an angular position in which a first printing plate located on the plate cylinder 10 can be removed. The first printing plate is then removed from the plate cylinder 10 and a second printing plate is brought up and secured to the plate cylinder 10. The plate cylinder 10 with the second printing plate is then turned by the direct drive into an angular position appropriate for the printing process. At the same time the printing plates on the plate cylinder 10 are changed and with pressure contact interrupted between plate and rubber blanket cylinders 10, 8, a cleaning device 7 is placed on the rubber blanket cylinder 8, the rubber blanket is cleaned, and then the cleaning device 7 is removed. The rubber blanket cylinder 8 and the plate cylinder 10 carrying the second printing plate are then brought back into pressure contact in the contact zone.

The invention concerns a method for controlling a machine for processing sheet material with at least one printing and/or varnishing unit according to the preamble of the independent claims.

A processing machine of this kind with a controllable direct drive for a single driven cylinder is known from EP 0 812 683 A1. Decoupled from the gear train of a sheet offset printing machine provided at least for the transport of the sheet material, a plate cylinder or rubber blanket cylinder of at least one printing unit can be driven directly by means of an individual drive in a predetermined manner. By means of the individual plate cylinder, which can be driven independently of the other cylinders, processes such as plate-changing or cylinder cleaning are carried out, in addition to printing corrections.

The underlying problem of the invention is to create a method of the above mentioned kind that noticeably reduces the setup time on a machine for processing sheet material with at least one individually-driven cylinder carrying a printing plate.

The problem is solved by the configuration features of Claims 1, 4, 6 and 8. Additional modifications are shown in the dependent claims.

A first benefit of the method for controlling a processing machine with at least one directly driven cylinder consists in that a definite shortening of the setup time is achieved by the controlled, simultaneous combination of formerly individually or sequentially performed work processes on a processing machine.

A second benefit is that the exchanging of a first printing plate for a second one (printing plate change) is accomplished on a plate cylinder of an offset printing unit and/or on a mold cylinder of a varnishing unit of a printing or varnishing machine which processes sheet material, and at the same time as the changing of the printing plate the cleaning of at least one cylinder occurs, especially a rubber blanket cylinder and/or some other cylinder transporting sheet material (sheet guide cylinder), preferably a form cylinder.

A third benefit is that, preferably prior to the changing of printing plates on the plate cylinder, the inking unit's rollers and the respective printing plate are cleaned by means of a familiar inking unit washing device. As a result, one will always take away a cleaned printing plate from the plate cylinder by means of the printing plate-changing device, a new printing plate can be brought up to the plate cylinder, and one avoids possible soiling of the printing plate-changing device or parts making contact with it from an uncleaned or inadequately cleaned printing plate.

Alternatively, it is possible by means of the printing plate-changing device to replace a first, still-inked (printed) printing plate with a second printing plate on the plate cylinder. But in this case—as already mentioned—there is a possibility of soiling the printing plate-changing device.

Furthermore, when the printing plate on the plate cylinder is in contact with the rubber blanket on the rubber blanket cylinder, the printing ink on an inked printing plate can be removed or noticeably reduced by printing a certain number of sheets with the rubber blanket cylinder or rubber blanket after first interrupting the ink feed to the printing plate. A printing plate with removed or noticeably reduced printing ink can then be replaced with a second printing plate by the printing plate-changing device, or the printing plate can be further cleaned by means of the printing unit's washing device (with ink applicator rollers in place).

A fourth benefit to be mentioned is that the particular printing plate is cleaned by means of a cleaning device, preferably with printing contact interrupted between the form cylinder and the sheet guide cylinder, preferably before the changing of the printing plates on the form cylinder. As a result, a cleaned printing plate will always be taken away from the form cylinder by means of the printing plate-changing device, a new printing plate can be brought up to the form cylinder, thus avoiding possible soiling of the printing plate-changing device, or parts making contact with it, by an uncleaned or inadequately cleaned printing plate.

Alternatively, it is possible by means of the printing plate-changing device to replace a first printed printing plate with a second printing plate on the form cylinder. But in this case—as already mentioned—there is a possibility of soiling.

If required, the dispensing system coordinated with the form cylinder, such as a chamber doctor blade with screened applicator roller, can be cleaned at the same time that the printing plate is changed of.

A fifth benefit is that ink or varnish coming from a dispensing system is transported to at least one applicator roller that can be brought into contact with the printing plate at the same time as the changing of the printing plate on the plate cylinder or on the form cylinder.

The invention will be explained in more detail using a sample embodiment. This shows schematically:

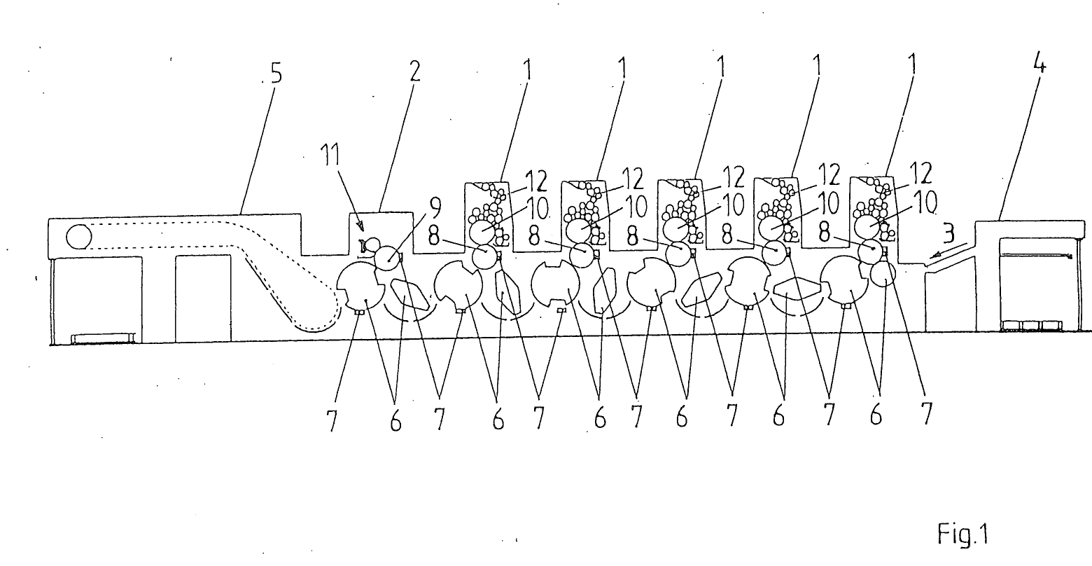

FIG. 1, a sheet-fed rotary letterpress with several printing units and one varnishing unit.

The sheet-fed letterpress rotary is shown, for example, with one feed unit 4, five offset printing units 1, one varnishing unit 2, and a delivery unit 5. Each offset printing unit 1 has, in familiar manner, one inking unit 12, one plate cylinder 10, and one rubber blanket cylinder 8. If need be, a wetting unit is coordinated with each plate cylinder 10. The varnishing unit 2 has, in familiar manner, a supply unit 11 for the medium being processed (varnish, ink), such as a chamber doctor blade with coordinated screened applicator roller, and a form cylinder 9. Plate cylinders 10 and form cylinder 9 each carry at least one printing plate.

Several sheet guide cylinders 6 are provided for sheet transport in the delivery direction 3. In each printing or varnishing unit 1, 2, a sheet guide cylinder 6 configured as a printing cylinder is in functional connection with the respective rubber blanket cylinder 8 or form cylinder 9, while in the first printing unit 1 the sheet guide cylinder 6 configured as a printing cylinder is preceded by a laying drum as the sheet guide cylinder 6. For sheet transport, additional sheet guide cylinders 6 are arranged as transfer cylinders between the sheet guide cylinders 6 configured as printing cylinders of the printing and varnishing units 1, 2.

A cleaning device 7 is coordinated with each rubber blanket cylinder 8, preferably each form cylinder 9 and each sheet guide cylinder 6 preferably configured as a printing cylinder. Each inking unit 12 has a washing device, such as a detergent spray system directed at the roller train, as well as an adjustable doctoring device on a last roller of the inking unit in the direction of rotation of the plate cylinder 10.

At least all of the sheet guide cylinders 6 are coupled together via a main drive gear train, not illustrated more closely. Each plate cylinder 10 and preferably each form cylinder 9 is operated by a direct drive, i.e., a separate drive motor. These direct drives are applied in a predetermined manner at least with respect to the sheet guide cylinders 6.

Each rubber blanket cylinder 8 is powered in a first embodiment by means of the main drive via a gear train of the sheet guide cylinder 6. In a second embodiment, each rubber blanket cylinder 8 is driven by a direct drive, i.e., a separate drive motor, mechanically decoupled from plate cylinder 10 and sheet guide cylinder 6. Such a direct drive is applied in a predetermined manner at least with respect to the sheet guide cylinders 6.

The method of controlling the processing machine is effected as follows at each offset printing unit 1 or varnishing unit 2.

A pressure contact is interrupted in a contact zone between the directly driven cylinder 10, carrying the printing plate and configured as a plate cylinder of an offset printing unit 1, and a neighboring rubber blanket cylinder 8.

After this, the plate cylinder 10 is turned by means of direct drive from its present angular arrangement into an angular position for removal of a first printing plate located on the plate cylinder 10. Next, the first printing plate is removed from the directly driven plate cylinder 10 and a second printing plate is brought up to the plate cylinder 10 and secured to it. Next, the plate cylinder 10 with the second printing plate is turned by means of direct drive into an angular arrangement for the printing process. At the same time as the above-described changing of the printing plates on the plate cylinder 10 and with pressure contact interrupted between plate and rubber blanket cylinders 10, 8, a cleaning device 7 is placed on the rubber blanket cylinder 8, the rubber blanket is cleaned, and then the cleaning device 7 is removed from the rubber blanket cylinder 6. After this, the rubber blanket cylinder 8 and the plate cylinder 10, now carrying the second printing plate, are again brought into pressure contact in the contact zone.

During the changing of printing plates on the plate cylinder 10 and the cleaning of the rubber blanket on the rubber blanket cylinder 8, a cleaning device 7 is placed on a sheet guide cylinder 6 driven by means of a main drive and gear train, its cylinder envelope surface is cleaned, and then the cleaning device 7 is removed again.

The cleaning device 7 can in particular be placed on and removed from a sheet guide cylinder 6 configured as a printing cylinder (offset printing unit 1), so that while changing the printing plate on the plate cylinder 10 for each offset printing unit 1, the rubber blanket on the rubber blanket cylinder 8 and the sheet guide cylinder 6 adjoining the rubber blanket cylinder 8 are cleaned at the same time. If needed, the sheet guide cylinder 6 configured as a printing cylinder is also cleaned independently of the rubber blanket cylinder 8.

Preferably the pressure contact between plate cylinder 10 and rubber blanket cylinder 8 is interrupted before changing a printing plate on the plate cylinder 8 [sic; 10] and the inking unit's rollers and the printing plate on the directly driven plate cylinder 10 are cleaned by means of an inking unit washing device. In this way, a cleaned printing plate is always available on the directly driven plate cylinder 1 for the next exchange of printing plates.

A pressure contact is interrupted in a contact zone between the directly driven cylinder 9, carrying the printing plate and configured as a form cylinder of a varnishing unit 2, and a neighboring sheet guide cylinder 6. The form cylinder 9 is turned by means of direct drive from its present angular arrangement into an angular position for removal of a first printing plate located on the form cylinder 9, the first printing plate is removed from the form cylinder 9 and a second printing plate is brought up to the form cylinder 9 and secured to it. Then the form cylinder 9 with the second printing plate is turned by means of direct drive into an angular arrangement for the printing process (varnishing process).

At the same time as the changing of the printing plates on the directly driven form cylinder 9 and with pressure contact interrupted between form cylinder 9 and the sheet guide cylinder 6, configured as a printing cylinder, a cleaning device 7 is placed on this sheet guide cylinder 6 driven by means of a main drive and gear train, its cylinder envelope surface is cleaned, and the cleaning device 7 is then removed. After this, the sheet guide cylinder 6 and the form cylinder 9, now carrying the second printing plate, are again brought into pressure contact in the contact zone.

Preferably the pressure contact between form cylinder 9 and the sheet guide cylinder 6 configured as a printing cylinder is interrupted before the changing of a printing plate on the directly driven form cylinder 9, and the printing plate on the form cylinder 9 is cleaned by means of a cleaning device 7 which can be placed on and taken off. Preferably the form roller, such as a screened roller, adjacent to the form cylinder 9, can be placed on and taken off and it is out of contact with the form cylinder 9 during the cleaning.

A pressure contact is interrupted in a contact zone between the directly driven cylinder 10, carrying the printing plate and configured as a plate cylinder of an offset printing unit 1, and a neighboring rubber blanket cylinder 8.

The plate cylinder 10 is turned by means of direct drive from its present angular arrangement into an angular position for removal of a first printing plate located on the plate cylinder 10, the first printing plate is removed from the plate cylinder 10, and a second printing plate is brought up to the plate cylinder 10 and secured to it. The plate cylinder 10 with the second printing plate is then turned by means of direct drive into an angular arrangement for the printing process, and at the same time ink or varnish coming from a dispensing system is transported to at least one applicator roller.

Preferably at least one inking roller train is arranged between the dispensing system and the at least one applicator roller.

A pressure contact is interrupted in a contact zone between the directly driven cylinder 9, carrying the printing plate and configured as a form cylinder of a varnishing unit 2, and a neighboring sheet guide cylinder 6, configured as a printing cylinder. The form cylinder 9 is turned by means of direct drive from its present angular arrangement into an angular position for removal of a first printing plate located on the form cylinder 9, the first printing plate is removed from the form cylinder 9, and a second printing plate is brought up to the form cylinder 9 and secured to it. The form cylinder 9 with the second printing plate is then turned by means of direct drive into an angular arrangement for the printing process, and at the same time ink or varnish coming from a dispensing system is transported to at least one applicator roller.

### LIST OF REFERENCE NUMBERS

1 Offset printing unit
2 Varnishing unit
3 Delivery direction
4 Feed unit
5 Delivery unit
6 Sheet guide cylinder
7 Cleaning device
8 Rubber blanket cylinder
9 Form cylinder (directly driven cylinder)
10 Plate cylinder (directly driven cylinder)
11 Supply device
12 Inking unit

1-10. (canceled)

11. A method for controlling a machine for processing sheet material with at least one printing and/or varnishing unit, comprising the steps of:
coupling a plate cylinder of an offset printing unit to a direct drive, the plate cylinder being mechanically decoupled from a main drive acting on the gear train of sheet guide cylinders and being drivable in a predetermined manner with respect to the sheet guide cylinders;
interrupting pressure contact in a contact zone between the plate cylinder and an adjacent rubber blanket cylinder;
turning the plate cylinder via the direct drive into an angular position for removal of a first printing plate arranged on the plate cylinder;
removing the first printing plate from the plate cylinder and bringing up and securing a second printing plate to the plate cylinder; and
turning the plate cylinder with the second printing plate via the direct drive into an angular arrangement for a printing process;
placing a cleaning device on the rubber blanket cylinder, cleaning the rubber blanket and removing the cleaning device at the same time as the changing of the printing plates on the plate cylinder and with pressure contact between plate and rubber blanket cylinders interrupted; and
re-establishing pressure contact in the contact zone between the rubber blanket cylinder and the plate cylinder now carrying the second printing plate.

12. The method according to claim 11 further including the steps of placing a cleaning device on a sheet guide cylinder driven by the main drive and gear train, cleaning the surface of the sheet guide cylinder, and removing the cleaning device during changing of the printing plates on the plate cylinder and the cleaning of the rubber blanket.

13. The method according to claim 11 wherein pressure contact between the plate cylinder and rubber blanket cylinder is interrupted before the changing of a printing plate on the plate cylinder and further including the step of cleaning rollers of an inking unit and the first printing plate on the plate cylinder using an inking unit washing device.

14. The method according to claim 11 wherein the rubber blanket cylinder is driven by the main drive via a gear train of the sheet guide cylinder.

15. The method according to claim 11 wherein the rubber blanket cylinder is driven by a separate direct drive.

16. A method for controlling a machine for processing sheet material with at least one printing and/or varnishing unit comprising the steps of:
coupling a form cylinder of a varnishing unit that is mounted in side frames to a direct drive, the form cylinder being mechanically decoupled from a main drive acting on the gear train of the sheet guide cylinders and can being drivable in a predetermined manner with respect to the sheet guide cylinders,
interrupting pressure contact in a contact zone between the form cylinder and an adjacent sheet guide cylinder;
turning the form cylinder via the direct drive into an angular position for removal of a first printing plate arranged on the form cylinder;
removing the first printing plate from the form cylinder and bringing up and securing a second printing plate to the form cylinder;
turning the form cylinder with the second printing plate via the direct drive into an angular arrangement for a printing process;
placing a cleaning device on the sheet guide cylinder, cleaning the surface of the sheet guide cylinder and removing the cleaning device at the same time as the changing of the printing plates on the form cylinder and with pressure contact interrupted between the form cylinder and the sheet guide cylinder; and
re-establishing pressure contact in the contact zone between the sheet guide cylinder and the form cylinder now carrying the second printing plate.

17. The method according to claim 16 wherein pressure contact between the form cylinder and sheet guide cylinder is interrupted before the changing of a printing plate on the form cylinder and further including the step of cleaning the first printing plate on the form cylinder using a cleaning device.

18. A method for controlling a machine for processing sheet material with at least one printing and/or varnishing unit comprising the steps of:
coupling a plate cylinder of an offset printing unit to a direct drive, the plate cylinder being mechanically decoupled from a main drive acting on the gear train of sheet guide cylinders and being drivable in a predetermined manner with respect to the sheet guide cylinders;
interrupting pressure contact in a contact zone between the plate cylinder and an adjacent rubber blanket cylinder;
turning the plate cylinder via the direct drive into an angular position for removal of a first printing plate arranged on the plate cylinder;
removing the first printing plate from the plate cylinder and bringing up and securing a second printing plate to the plate cylinder; and
turning the plate cylinder with the second printing plate via the direct drive into an angular arrangement for a printing process; and
transporting at the same time ink or varnish from a dispensing system to at least one applicator roller.

19. The method according to claim 18 wherein at least one inking roller train is arranged between the dispensing system and the at least one applicator roller.

20. The method according to claim 18 wherein the rubber blanket cylinder is driven by the main drive via a gear train of the sheet guide cylinder.

21. The method according to claim 18 wherein the rubber blanket cylinder is driven by a separate direct drive.

22. A method for controlling a machine for processing sheet material with at least one printing and/or varnishing unit comprising the steps of:
coupling a form cylinder of a varnishing unit that is mounted in side frames to a direct drive, the form cylinder being mechanically decoupled from a main drive acting on the gear train of the sheet guide cylinders and can being drivable in a predetermined manner with respect to the sheet guide cylinders,
interrupting pressure contact in a contact zone between the form cylinder and an adjacent sheet guide cylinder;
turning the form cylinder via the direct drive into an angular position for removal of a first printing plate arranged on the form cylinder;
removing the first printing plate from the form cylinder and bringing up and securing a second printing plate to the form cylinder;
turning the form cylinder with the second printing plate via the direct drive into an angular arrangement for a printing process; and
transporting at the same time ink or varnish from a dispensing system to at least one applicator roller.
